(19) United States
(12) Patent Application Publication
(10) Pub. No.: US 2015/0314235 A1
(43) Pub. Date: Nov. 5, 2015

(54) CARBON DIOXIDE SCRUBBING PROCESS

(71) Applicants: Pavel Kortunov, Flemington, NJ (US); Michael Siskin, Westfield, NJ (US); Eugene R. Thomas, Pittstown, NJ (US); Hans Thomann, Bedminster, NJ (US)

(72) Inventors: Pavel Kortunov, Flemington, NJ (US); Michael Siskin, Westfield, NJ (US); Eugene R. Thomas, Pittstown, NJ (US); Hans Thomann, Bedminster, NJ (US)

(73) Assignee: EXXONMOBIL RESEARCH AND ENGINEERING COMPANY, Annandale, NJ (US)

(21) Appl. No.: 14/268,174

(22) Filed: May 2, 2014

(51) Int. Cl. B01D 53/62; B01D 53/14

(52) U.S. Cl. CPC B01D 53/62; B01D 53/1493; B01D 53/1475; B01D 53/1425; B01D 2258/0283; B01D 2252/30

(57) ABSTRACT

A cyclic process for separating CO₂ from a gas stream by contacting the gas stream at a first temperature and typically at a pressure of at least 30 barg with a CO₂ sorbent comprising an ionic liquid containing a potentially nucleophilic carbon atom bearing a relatively acidic hydrogen atom bonded to a potentially nucleophilic carbon atom to sorb CO₂ into the solution and regenerating the ionic liquid absorbent by treating the sorbent under conditions including a second, typically higher, temperature, to cause desorption of at least a portion of the CO₂ and to regenerate the ionic liquid.

### FIELD OF THE INVENTION

This invention relates to the removal of carbon dioxide and other acid gases from a gaseous stream containing one or more of these gases. In particular, the invention relates to a method for separating carbon dioxide from natural gas at high pressures.

### BACKGROUND OF THE INVENTION

The removal of carbon dioxide from mixed gas streams is of great industrial importance and commercial value. Carbon dioxide is a ubiquitous and inescapable by-product of the combustion of hydrocarbons and there is growing concern over its accumulation in the atmosphere and its potential role in a perceived global climate change. Laws and regulations driven by environmental factors may therefore soon be expected to require its capture and sequestration. While existing methods of CO₂ capture have been adequately satisfactory for the scale in which they have so far been used, future uses on the far larger scale required for significant reductions in atmospheric CO₂ emissions from major stationary combustion sources such as power stations fired by fossil fuels makes it necessary to improve the processes used for the removal of CO₂ from gas mixtures.

Another area where more efficient CO₂ separation processes are needed is in enhanced oil recovery (EOR) where CO₂ is re-injected into the gas or liquid hydrocarbon deposits to maintain reservoir pressure e.g. with gas from fields such as LaBarge, Wyo. which contains about 65% CO₂. With the advanced age of many producing reservoirs worldwide and the ever-increasing challenge of meeting demand, the expanding use of EOR methods is becoming more widespread. Typically the source of carbon dioxide for EOR is the producing hydrocarbon stream itself, which may contain anywhere from less than 5% to more than 80% of CO₂. Other options are to capture CO₂ from the flue gases of various combustion sources and pre-combustion capture of CO₂ from shifted syngas produced in fuel gasification processes. It may also be necessary to remove H₂S to enable the product gas to meet maximum H₂S specifications for pipelining. In cases such as these, the overall selectivity of CO₂ pickup may need to be optimized when maximum selectivity is not required.

Cyclic CO₂ absorption technologies such as Pressure Swing Absorption (PSA) and Temperature Swing Absorption (TSA) using liquid absorbents are well-established. The absorbents mostly used include liquid solvents, as in amine scrubbing processes, although solid sorbents are also used in PSA and TSA processes. Liquid amine absorbents, including alkanolamines, dissolved in water are probably the most common absorbents. Amine scrubbing is based on the chemical reaction of CO₂ with amines to generate carbonate/bicarbonate and carbamate salts: the aqueous amine solutions chemically trap the CO₂ via formation of one or more ammonium salts (carbamate/bicarbonate/carbonate) which are thermally unstable, enabling the regeneration of the free amine at moderately elevated temperatures. Commercially, amine scrubbing typically involves contacting the CO₂ and/or H₂S containing gas stream with an aqueous solution of one or more simple amines (e.g., monoethanolamine (MEA), diethanolamine (DEA) or triethanolamine (TEA)). MEA's low molecular weight makes it economically attractive because sorption takes place on a molecular basis while the amine is sold on a weight basis. The cyclic sorption process requires high rates of gas-liquid exchange, the transfer of large liquid inventories between the absorption and regeneration steps, and high energy requirements for the regeneration of amine solutions. It is challenged by the corrosive nature of the amine solutions containing the sorbed CO₂.

Cyclic absorption processes using aqueous sorbents generally require a large temperature or pressure differential in the gas stream between the absorption and desorption (regeneration) parts of the cycle. In conventional aqueous amine scrubbing methods relatively low temperatures, e.g., less than 50° C., are required for CO₂ uptake, with an increase to a temperature above about 100° C., e.g., 120° C., required for the desorption. The heat required to maintain the thermal differential is a major factor in the cost of the process. With the need to regenerate the solution at temperatures above 100° C., the high latent heat of vaporization of the water (2260 kJ/Kg at 100° C.) obviously makes a significant contribution to the total energy consumption. If CO₂ capture is to be conducted on the scale appropriate to use EOR projects and with treatment of natural gas containing major proportions of CO₂, more effective and economical separation techniques need to be developed. Similarly, the need for large swings in pressure between the absorption and desorption/regeneration steps has imposed an added cost in operation with the need to recompress the absorbent prior to entry into the absorption tower.

The use of sterically hindered amines for CO2 capture was proposed by Sartorl and Savage in “Sterically Hindered Amines for CO2 Removal from Gases,” Ind. Eng. Chem. Fundamen.”, 1983, 22(2), 239-249, pointing out that sterically hindered amines have unique capacity and rate advantages in CO2 sorption processes: their rich solutions can be desorbed to a greater extent than their non-substituted counterparts, thus producing a leaner solution (lower total carbamate/bicarbonate/carbonate concentration), which tends to result in a greater mass transfer upon reabsorption.

Various commercial CO₂ capture processes have been brought to market. The Fluor Daniel Econamine™ Process (originally developed by Dow Chemical and Union Carbide), which uses MEA for recovery of CO₂ from flue gases, primarily for EOR applications, has a number of operational plants. The Benfield™ Process using hot potassium carbonate is used in many ammonia, hydrogen, ethylene oxide, and natural gas plants, with over 675 units worldwide licensed by UOP, and has been proposed for treating flue gas, notwithstanding its minimum CO₂ partial pressure requirement of 210 to 345 kPag (30-50 psig). One feature of the Benfield Process is its use of a high temperature stripping step (175° C.), approximately 75-100° C. above the temperature of the absorption step. The Catacarb™ process, also using hot potassium carbonate, also uses high temperature stripping, resulting in high energy consumption.

Processes using sterically hindered amines as alternatives to MEA, DEA and TEA have also achieved success, including the ExxonMobil Flexsorb™ Process and the KS™ Process from Mitsubishi Heavy Industries and Kansai Electric Power Co. Processes using solid absorbents are also known and while they may avoid many of the limitations of amine scrubbing, they suffer from a lack of absorbents having sufficiently selective CO₂ absorption.

### SUMMARY OF THE INVENTION

We have now identified chemisorbents that can be regenerated at high pressure and relatively low temperature and so are capable of reducing the cost and energy required for regeneration and recompression. According to the current invention these liquid chemisorbents are used for the removal of CO₂ and/or H₂S from natural gas (including shale gas) at high pressures, typically over 10 barg (about 150 psig) and, in most cases, at least 70 bar (1050 psig). Targeting effective and highly selective capture of acid gases from natural gas, the liquid sorbents used in the present treatment process may comprise chemisorptive ionic liquids in nonaqueous solutions; mixtures of these ionic liquids with amines, other bases and amine/base mixtures also fall for possible use. These sorbents may also offer a lower regeneration energy compared to currently used amines, which can potentially benefit the process overall economics and the footprint of the gas treatment units using them.

According to the present invention, the absorbents comprise chemisorptive ionic liquids either by themselves or, for more effective functioning, with bases acting as promoters/stabilizers in non-aqueous sorbents. In its practical mode of operation, it is operated as a cyclic process which comprises:
a) contacting the gas stream at a first temperature and at a pressure of at least 10 barg with a CO₂ sorbent comprising an ionic liquid containing a potentially nucleophilic carbon atom bearing a relatively acidic hydrogen atom bonded to a potentially nucleophilic carbon atom to sorb CO₂ into the solution; and
b) treating the sorbent containing the sorbed CO₂ under conditions including a second temperature, to cause desorption of at least a portion of the CO₂ and to regenerate the ionic liquid.

When the organic base promoter is used, a non-nucleophilic nitrogenous base having a pKa of at least 10.0 (25° C. aqueous equivalent scale) or 12 is preferred, for example, a carboxamidine or guanidine. In the ionic liquid, the relatively acidic hydrogen atom of the ionic liquid cation is preferably bonded to a potentially nucleophilic carbon atom in a conjugated —NC(H)N— structure or a —NC(H)S— structure, for example, in an imidazolium, imidazolidinium, benzimidazolium or thiazolium salt which preferably has a counterion derived from an organic acid with a pKa of at least 4.0, e.g. preferably an acetate or other carboxylate salt.

### DRAWINGS

In the accompanying drawings:

FIG. 1 is a simplified schematic of a cyclic gas treatment unit.

FIG. 2 is a graph showing the pressure/absorption relationship for absorption of CO2 in ionic liquid in dimethyl sulfoxide (DMSO) solution.

FIG. 3 is a graph showing the pressure/absorption relationship for absorption of CO2 in ionic liquid promoted by tetramethylguanidine (TMG) in dimethyl sulfoxide (DMSO).

### DETAILED DESCRIPTION

### Absorption Unit

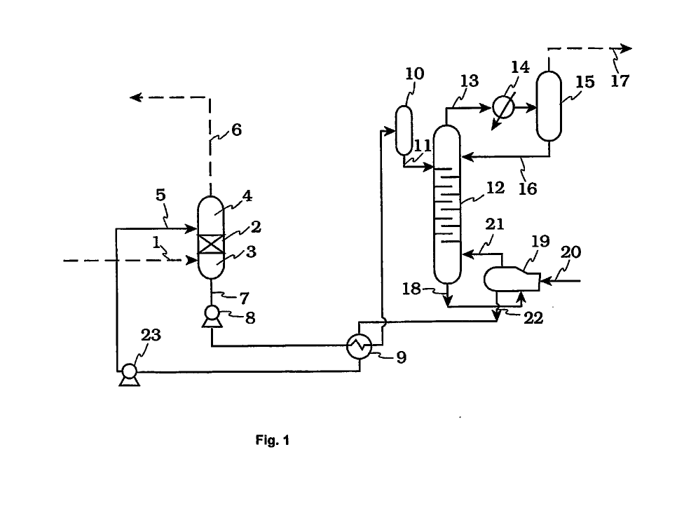

FIG. 1 shows in very much simplified form a cyclic gas treatment unit using a liquid absorbent. In the unit, the gas mixture to be purified is introduced through line 1 into the lower portion of a gas-liquid countercurrent contacting column 2, said contacting column having a lower section 3 and an upper section 4. The upper and lower sections may be segregated by one or a plurality of packed beds as desired. The lean absorbent solution is introduced into the upper portion of the column through conduit 5. The solution flowing to the bottom of 35 the column encounters the countercurrent gas flow and dissolves the acid gas. The gas freed from most of the gas absorbed in the liquid exits through a conduit 6 for final use. The rich solution, containing mainly absorbed acid gas, flows toward the bottom portion of the column from which it is discharged through conduit 7. The solution is then pumped via optional pump 8 through an optional heat exchanger and cooler 9 disposed in conduit 7, which allows the hot solution from the regenerator 12 to exchange heat with the cooler solution from the absorber column 2 for energy conservation. The solution enters via line 7 to a flash drum 10 equipped with a line (not shown) which vents to line 13 and then introduced by 11, into the upper portion of the regenerator 12, which is equipped with several plates and effects the desorption of the gases carried along in the solution. This acid gas mixture is passed through a pipe 13 into a condenser 14 where cooling and condensation of water and amine solution from the gas occur. The gas then enters a separator 15 where 55 further condensation is effected. The condensed solution is returned through pipe 16 to the upper portion of the regenerator 12. The gas remaining from the condensation is removed through pipe 17 for final disposal or treatment.

The solution is liberated from most of the gas which it contains while flowing downward through the regenerator 12 and exits through line 18 at the bottom of the regenerator for transfer to a reboiler 19. Reboiler 19, equipped with an external source of heat (e.g., steam injected through pipe 20 and the condensate exits through a second pipe (not shown)), vaporizes a portion of this solution (mainly water) to drive out further absorbed gas. The acid gas and steam driven off are returned via line 21 to the lower section of the regenerator 12 and exit through line 13 for entry into the condensation stages of gas treatment. The solution remaining in the reboiler 19 is drawn through pipe 22, cooled in heat exchanger 9, and introduced via pump 23 (optional if pressure is sufficiently high) through pipe 5 into absorber column 2.

### Liquid Absorbents

The options are available for the choice of the absorbent liquid are addressed in turn below.

### 1. Chemisorptive Ionic Liquids in Non-Aqueous Sorbents

The first class of liquid absorbents that commend themselves for use as CO₂ absorbents in high pressure sorption processes are the chemisorptive ionic liquids. The ionic liquids which have been found to be highly effective for CO2 sorption sorbents include those compounds in which the cation contains a relatively acidic hydrogen atom bonded to a potentially nucleophilic carbon atom, as in cations having a C—H bond present as part of a conjugated —NC(H)N— structure and/or of an —NC(H)S— structure, more specifically designated as a —N═C(H)—N— structure and/or as an —N═C(H)—S— structure, for example, as in imidazolium, benzimidazolium, imidazolidinium (4,5-dihydro-IH-imidazolium), diazolium, and thiazolium salts with a hydrogen at the 2-position. The carbon referred to as nucleophilic can be qualified as potentially nucleophilic, since the carbon itself typically does not become a nucleophile until deprotonation of the acidic hydrogen. Thus, cations that can be effective to achieve chemisorption of CO₂ can advantageously be those in which the potentially nucleophilic carbon can bear a sufficiently acidic hydrogen (on a relative basis) to be susceptible to deprotonation by reaction of the cation and subsequent reaction with CO₂. Organic cations with pK[a] (acid dissociation equilibrium constant) values, as measured or predicted at −25° C. in DMSO (dimethyl sulfoxide) solution and/or as measured in other solvent and converted to a DMSO value (referred to as DMSO equivalent scale), can be below about 26, for example from about 26 to about 15, from about 25 to about 16, or from about 24 to about 18 (based on the values in the Bordwell online pK[a] database, http://www.chem.wisc.edu/areas/reich/pkatable/index.htm); the lattermost range effectively covering the imidazolium compounds likely to provide enhanced/optimal CO2 sorption by the ionic liquid. The salts derived from the imidazolium cation can be preferred, without being bound by theory, in some embodiments because their almost planar structure makes them have the character of amidines, particularly those derived from the 1,3-di(lower alkyl) imidazolium cations, where lower alkyl is Ci-C[6] (preferably C[1]-C4) alkyl. However, the 1,3-substituents of the imidazolium, benzimidazolium, and/or imidazolidinium cations and/or the N— substituents of the thiazolium cations may include or be other groups, such as aryl (including mesityl (2,4,6-trimethylphenyl)), higher alkyl (e.g., C7-C24), cycloalkyl, alkenyl (e.g., C1-C6), hydroxyalkyl (e.g., hydroxy-functionalized C1-C6), glycol ether, and substituted (C1-C16, e.g., C1-C6) alkyl, wherein a substituent of the alkyl group is a heteroatomic group, aryl, alkenyl, and/or other functionality. The imidazolium, benzimidazolium, thiazolium, and/or imidazolidinium cations may additionally or alternately bear substituents of similar nature at the ring carbon atom positions which do not react with CO2 via the acidic hydrogen atom.

In the absence of a non-nucleophilic nitrogenous base promoter as described below, it appears that the pKa of the anion of the ionic liquid may be effective to vary the liquid's capability to react with CO₂. In this case, preferred anions for forming salts with the cations of the ionic liquid can include those in which the conjugate acid of the counterion has a pKa as measured and/or predicted at −25° C. in aqueous solution (or as measured in other solvent and converted to an aqueous value, referred to as aqueous equivalent scale) of at least 0, for example of at least 2.0 or of at least 4.0. The anion of the ionic liquid salt can affect its ability to act as an agent for CO₂ capture, with more basic anions (such as acetate and/or thiocyanate) enhancing chemisorption and less basic anions (such as chloride) being ineffective and/or less effective in enhancing chemisorption. A useful means of making an adequate prediction of the pK[a] value of the counterion can include use of the ACD/PhysChem Suite™ (a suite of software tools for the prediction of basic physicochemical properties including pK[a]), available from Advanced Chemistry Development, Inc., 110 Yonge Street, Toronto, Ontario, Canada M5C 1T4.

A preferred class of imidazolium salts includes the 1,3-dialkyl substituted imidazolium salts, with preference for the acetate salts as exemplified by l-ethyl-3-methyl imidazolium acetate and 1-butyl 1-3-methyl imidazolium acetate, but other salts may be considered, such as those with halide, thiocyanate, and/or lower alkyl chain carboxylate anions (including acetate, propionate, hexanoate, octanoate, decanoate, and the like, as well as combinations thereof) as well as methanesulfonate, thiocyanate, salicylate, tetracholoroaluminate-aluminum chloride, dioctylsulfosuccinate, alkylbenzenesulfonate (alkyl=e.g., dodecyl), trifluoromethyl sulfonate, sulfate, bromide, methanesulfonate, alkylsulfate, tetrachloroaluminate, dicyanamide, hexafluoroantimonate, bis(trifluoromethylsulfonyl)imide, iodide, trifluorosulfonate, nitrate, tosylate, bis(2,4,4-trimethylpentyl)phosphinate, dibutylphosphate, lactate, and the like, as well as combinations thereof.

The ionic liquid can advantageously be selected to be substantially liquid over the temperature range at which the process is to be operated. Normally, the melting point of the liquid can therefore be at least −10° C. (e.g., at least −20° C.). Similarly, the boiling point can be sufficiently high to preclude significant evaporation at process operating temperatures, although this is unlikely to be a significant problem with most ionic liquids, which are generally characterized by high boiling points. The viscosity of the liquid, especially when containing the chemisorbed CO₂, can be a factor to be controlled in order to maintain pumpability. This may be determined empirically, considering also the potential use of solvent and/or the concentration of the chemisorbed species in the liquid sorbent under process conditions.

These ionic liquid absorbents are described fully in U.S. Patent Publication No. 2012/0063977, to which reference is made for a description of these absorbents, their functionality in the absorption process and the conditions under which CO₂ absorption can take place.

The capability of the sorbent to react with the CO₂ may be enhanced by the use of a non-aqueous solvent. These non-aqueous solvents are typically aprotic solvents with more polar solvents being generally preferred over less polar solvents. A polar solvent can additionally or alternatively increase physical absorption of the CO₂, which can increase the concentration of CO₂ in solution, thereby facilitating increased loading and capacity of the absorbent. A significant advantage of the non-aqueous solvent can include a reduction in corrosivity of the acid gas solutions as compared to the aqueous-based systems, thereby enabling more extensive use of cheaper metallurgies, e.g., carbon steel, in associated equipment with reduced concern about corrosion at higher CO₂ loadings.

A solvent such as toluene with a relatively low dipole moment has been found to be effective, although, in general, higher values for the dipole moment (Debye) of at least 1.7, for example of at least 2, and preferably of at least 3, have been shown to have the greatest effect as with preferred solvents such as DMSO (dimethylsulfoxide), DMF (N,N-dimethylformamide), NMP (N-methyl-2-pyrrolidone), HMPA (hexamethylphosphoramide), THF (tetrahydrofuran), sulfolane (tetramethylene sulfone), and the like. In addition to the preferred solvents being non-aqueous, polar, and aprotic, they preferably also have a boiling point of at least 65° C. (for example 70° C. or higher), in order to reduce solvent losses in the process, and higher boiling points tend to be more desirable, of course depending on the regeneration conditions which are to be used. If the regeneration is to be carried out at a temperature above 100° C., e.g., if so required for the desorption and/or to remove any water that may enter the system, a boiling point above 100° C., sometimes above 150° C. or even higher, may be preferable. Use of higher boiling point solvents can conserve valuable energy that could otherwise be consumed in vaporization of the solvent.

Solvents found effective to various extents can include toluene, sulfolane (tetramethylene sulfone), and dimethylsulfoxide (DMSO). Although toluene has a low dipole moment, indicating a low degree of polarity, it is adequately polar for use in the present process as shown by experiment. Other solvents of suitable boiling point and dipole moment could include, but are not-limited to, acetonitrile, dimethylformamide (DMF), tetrahydrofuran (THF), ketones such as methyl ethyl ketone (MEK), esters such as ethyl acetate and amyl acetate, halocarbons such as 1,2-dichlororobenzene (ODCB), and combinations thereof.

Non-aqueous solvents suitable for use with the non-ionic liquids are described in U.S. Patent Publication No. 2012/0061614 to which reference is made for a description of such liquids and their use in acid gas absorption processes.

### 2. Chemisorptive Ionic Liquids Promoted by Bases in Non-Aqueous Sorbents

Another class of liquid absorbents is the combination of an ionic liquid in a non-aqueous solvent as described above with the addition of a base as a promoter. The use of ionic liquids in combination with non-nucleophilic bases for CO₂ capture is described in U.S. Patent Application Publication No. 2012/0063977 to which reference is made for a description of these absorbents, their functionality in the absorption process and the conditions under which CO₂ absorption can take place. The non-aqueous solvents in which they are dissolved may enhance the capability of the sorbent to react with the CO₂. The non-aqueous solvents for use with the non-ionic liquids are described in U.S. Patent Publication No. 2012/0061614 to which reference is made for a description of such liquids and their use in acid gas absorption processes.

The ionic liquids which may be used in this way for CO₂ capture at high pressures are those described above and in U.S. 2012/0063977 to which reference is made. As noted there and taking imidazolium salts as an example of the ionic liquid, the sorption reaction with CO₂ can proceed by a reaction involving carboxylation at the C-2 carbon of the imidazole ring, as follows:

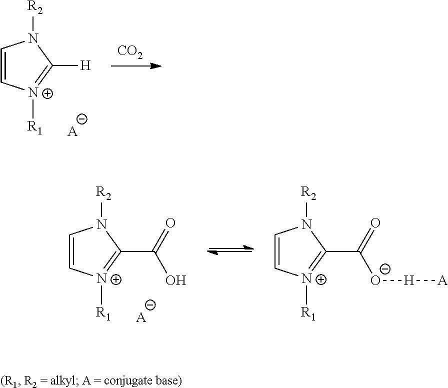

This reaction between the CO₂ and the ionic liquid can proceeds easily (and qualitatively or quantitatively reversibly) upon heating to provide a convenient liquid-phase CO₂ capture-regeneration process. A limited temperature differential between the sorption and desorption steps can make for an energy efficient cyclic separation process with the potential for a substantially isothermal sorption-desorption cycle.

The C-carboxylation reaction between CO₂ and the ionic liquid can be promoted by the presence of a strong non-nucleophilic nitrogenous base having a pKa as measured and/or predicted at about 25° C. in aqueous solution (or as measured in other solvent and converted to an aqueous value, referred to as aqueous equivalent scale) of at least 10.0, for example at least 12.0 or at least 13.0. The ACD/PhysChem Suite® may be used for making a prediction of the pKa value of the base in many cases. While bases such as tertiary amines with pKa's as low as about 10.0 can tend not to increase reaction yield with acetate-anion ionic liquids, they appear to have the potential to promote the reaction with thiocyanate-anion ionic liquids and other salts with counterions that may not favor optimal CO₂ sorption.

The base can advantageously be strong enough to influence the C-carboxylation product equilibrium effectively, but, on the other hand, advantageously not so strong as to sufficiently stabilize the carboxylated reaction product to the point of irreversibility, making desorption of the CO₂ from the carboxylated reaction product difficult or infeasible, e.g., by an inconveniently high temperature requirement. Additionally, the protonated form of the base should preferably remain quantitatively available to the ionic liquid for deprotonation/regeneration during the CO₂ desorption step of the cycle. Unacceptable bases can include those that give overly volatile protonated species, species that precipitate from the sorbent phase, species that may influence the reaction chemistry of CO₂ (e.g., hydroxide bases that form water upon protonation), and/or the like. The base should also preferably lack the propensity to act as a competing nucleophile towards CO₂ under the conditions of the sorption process. The non-nucleophilic nitrogenous bases selected according to the above criteria can function as excellent promoters for ionic liquid C-carboxylation with CO₂ in the chemisorption reaction.

When the non-nucleophilic nitrogenous base is used as a promoter for the ionic liquid chemisorption reaction, the base can appear to function as a Bronsted base, sequestering the proton of the C-carboxylation product (or at least influencing the C-carboxylation equilibrium) in such a way that larger yields can be obtained. The reaction, again using an imidazolium salt as an exemplary ionic liquid, may be represented as:

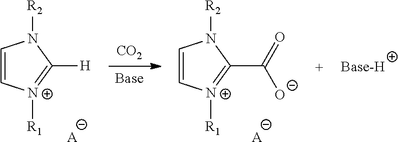

Non-nucleophilic nitrogenous bases useful for promoting the carboxylation reaction with the ionic liquid sorbents can include cyclic, multicyclic, and acyclic structures, such as imines, heterocyclic imines and amines, amidines (carboxamidines), including the N,N-di(lower alkyl) carboxamidines (e.g., lower alkyl preferably being C1-C6 alkyl), N-methyltetrahydropyrimidine, 1,8-diazabicyclo[5.4.0]-undece-7-ene (DBU), 1,5,7-triazabicyclo[4.4.0]dec-5-ene (TBD), 7-methyl-1,5,7-triazabicyclo[4.4.0]dec-5-ene (MTBD), 1,5-diazabicyclo[4.3.0]non-5-ene (DBN), guanidines, including substituted guanidines of the formula (R1R2N)(R3R4N)C═N—R5 where R1, R2, R3, and R4 are preferably lower alkyl (e.g., C1-C6) and R5 is preferably H, such as 1,1,3,3-tetramethylguanidine, and combinations thereof. Additionally or alternately, other substituents, such as higher alkyl, cycloalkyl, aryl, alkenyl, and substituted alkyl as defined previously, and other structures may be used. These strong nitrogenous bases can typically be used on a 1:1 molar basis with the ionic liquid, although they may be present or used in molar excess with a higher reaction yield expected with a higher concentration of base in the solution. Because such bases they can be non-nucleophilic under the conditions of the sorption process, they may advantageously not engage in an N-carboxylation reaction with CO₂.

The selected ionic liquid can function to trap the CO₂ by chemisorption. The ionic liquids have not shown themselves to be effective for non-reactive physisorption at low pressures, typically below 1 to 2 bara (100-200 kPaa); although both chemisorption and physisorption may take place under such conditions, one or the other may be the predominant mode of CO₂ uptake, depending upon the sorbent medium and operating conditions. Such low pressures can be typical of those encountered in treating flue gases from hydrocarbon combustion processes; the present process lends itself well to post combustion flue gas CO₂ capture when CO₂ partial pressures are in the range of about 0.03 to 2 bara (about 0.5 to 30 psia, or about 3 to 200 kPaa).

The ionic liquid and the non-nucleophilic nitrogenous base may be used alone or taken up in an aprotic, preferably polar non-aqueous solvent of the type described in U.S. Patent Application Publications Nos. 2012/0061614, to which reference is made for a description of such solvents and their use in a CO2 sorption process. In some embodiments, the use of the additional solvent can be less desirable, unless required to achieve a liquid of appropriate viscosity and pumpability, since it may diminish the sorption capacity of the system. If used, the solvent may typically be used in a ratio of up to about 1:1 molar (solvent:ionic liquid). Solvents such as toluene, dimethylsulfoxide, dimethylformamide, sulfolane, N-methyl-2-pyrrolidone, propylene carbonate, dimethyl ethers of ethylene and propylene glycols, tetrahydrofuran, and the like may accordingly be used.

The ionic liquids can additionally be capable of suppressing formation of the carbamate/bicarbonate product when water is present in the system. This can be significant, since, in the processing of natural gas streams, water may be introduced into the system. However, as discussed prior, if significant amounts of water are present in the CO₂-containing feedstreams, it is recommended that such stream be dewatered/dehumidified prior to contacting with the absorbent materials and processes described here.

Absorption/Desorption Conditions

In the present process, sorption of the acidic gases from the natural gas stream is carried out at high pressure, normally above 70 barg (1050 psig) at pressures of this magnitude the present sorption systems demonstrate a high cyclic absorption capacity, that is, a high proportion of sorbed CO₂ relative to the amine (molar basis, moles CO₂ per mol sorbent). At pressures of 10 barg the chemisorptive ionic liquids have been shown capable of sorbing up to about 0.5 moles CO₂ per mole of liquid (3M ionic liquid in DMSO) but with a strongly basic promoter such as TMG, the molar sorption increases to 0.8 moles under favorable temperature operation (45° C.). Higher sorption capacities on a molar basis can be achieved when using sorbents with multiple sorption sites such as DMAE (two sites) or TEA (three). DMAE with TMG promoter, for example has demonstrated a sorption capacity of 1.0 mole CO₂ per mole (45° C., DMSO) at 10 bar.

The relative extent to which the CO₂ is removed from the gas is dependent on total system pressure as well as CO₂ partial pressure. Natural gas recovery and processing is commonly at high pressure and may enter the treatment process at a pressure typically up to about 90 barg with the actual value selected being dependent on pipelining specifications and/or the extent to which it is desired to eliminate recompression following treatment, for example. Total system pressure can typically be in the range from a minimum of about 30, 40, 50 60, 60, 70, 80, 90 or 100 barg (respectively about 435, 580, 725, 870, 1015, 1160, 1300 or 1450 psig) to about 150 barg (about 2010 psig). All references to values of pressure in units of bars herein are in absolute pressures unless otherwise specifically noted. The partial pressure of carbon dioxide in the gas mixture can vary according to the gas composition and/or the pressure of operation. The proportion of CO₂ in natural gas (at the wellhead) may typically vary from a fraction of one percent up to more than 50 percent. The highest proportion of CO₂ in any known natural gas is 65 percent at the Shute Creek filed (LaBarge, Wis.), at 65% CO₂ with 21% methane, 7% nitrogen, 5% hydrogen sulfide (H₂S) and 0.6% helium. The present process is effective at separating CO₂ from natural gases containing such high proportions of the acidic contaminants, e.g. up to about 65 percent, up to 50 percent, up to 30 percent, up to 20 percent or up to 10 percent. The gas mixture can be contacted countercurrently or co-currently with the absorbent material at a gas hourly space velocity (GHSV) from about 50 (S.T.P.)/hour to about 50,000 (S.T.P.)/hour.

Regeneration may be carried out under temperature swing or pressure swing regimes appropriate to the selected absorbent. In temperature swing operation, the regeneration temperature is preferably maintained at a value under the boiling point of any solvent to eliminate using additional energy for evaporation and for this reason, the lower boiling point solvents are preferred.

### Example 1

An approximately 50 wt % solution (˜3 molar) of 1-butyl-3-methylimidazolium acetate in d6-DMSO was heated to ˜45° C. and then treated with a continuous flow of ˜1 vol % CO₂ in N₂ at ˜1 atm (˜100 kPag). The solution was next treated with ˜10 vol % CO₂ in N₂ at ˜1 atm (˜100 kPag), and finally with ˜100 vol % CO₂ at ˜1 atm. The equilibrium loading of CO₂ at these conditions was ˜12.2 mol %, ˜26.7 mol %, and ˜35.0 mol %, respectively, and represented an 1-butyl-3-methylimidazolium acetate/CO₂ vapor-liquid equilibrium at ˜10 mbar (˜1 kPa), ˜100 mbar (˜10 kPa), and ˜1 bar (˜100 kPa) of CO₂ at ˜45° C.

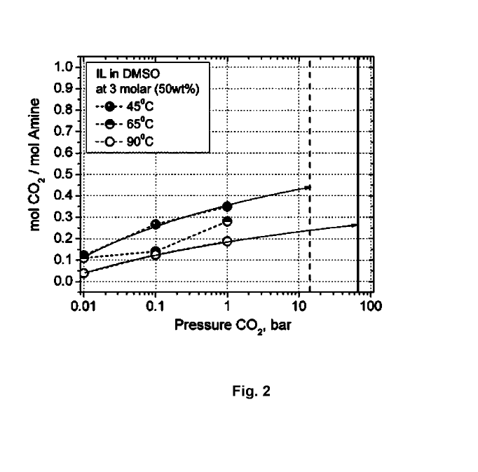

The same procedure was carried out with fresh ˜3 molar (˜49.6 wt %) 1-butyl-3-methylimidazolium acetate in DMSO-d6 solution at ˜65° C. and ˜90° C. The monitoring results shown in FIG. 2 indicated a strong temperature dependence of CO₂ uptake capacity. This result confirmed the relatively low stability of the reaction product, which can be beneficial for achieving lower regeneration energy.

### Example 2

An approximately 3 molar solution of 1-butyl-3-methylimidazolium acetate (˜53 wt %) and ˜3 molar of 1,1,3,3-tetramethylguanidine (˜34 wt %) in d6-DMSO was heated to ˜45° C. and then treated with a continuous flow of ˜1 vol % CO₂ in N₂ at ˜1 atm (˜100 kPag. The solution was next treated with ˜10 vol % CO₂ in N2 at ˜1 atm (˜100 kPag), and finally with ˜100 vol % CO₂ at ˜1 atm. The equilibrium loading of CO₂ at these conditions was ˜33.7 mol %, ˜60.7 mol %, and ˜70.2 mol %, respectively, and represented an 1-butyl-3-methylimidazolium acetate/CO₂ vapor-liquid equilibrium at ˜10 mbar (˜1 kPa), ˜100 mbar (˜10 kPa), and ˜1 bar (˜100 kPa) of CO₂ at ˜45° C.

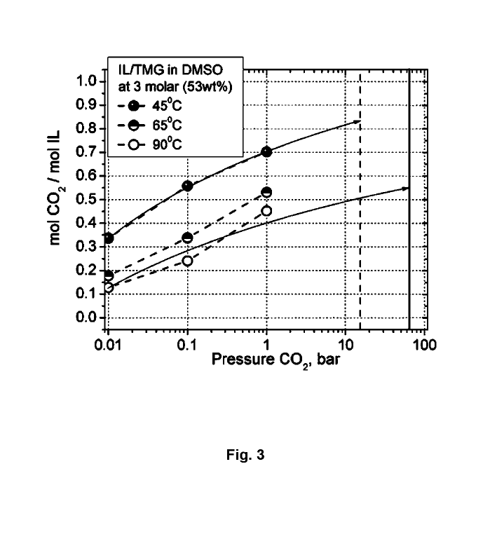

The same procedure was carried out with a fresh mixture of 1-butyl-3-methylimidazolium acetate and TMG in DMSO-d6 solution at ˜65° C. and ˜90° C. The monitoring results shown in FIG. 3 indicated a significantly higher CO₂ uptake capacity as a result of promotion with the strong base, TMG. The CO₂ uptake capacity appeared to be comparable to alkanolamines, and the strong temperature dependence of the vapor-liquid equilibrium for the given system confirmed potential application of neat or promoted ionic liquids for cost effective CO₂ capture from natural gas.

1. A cyclic process for separating CO₂ from a gas stream which process comprises:
a) contacting the gas stream at a first temperature and at a pressure of at least 10 barg with a CO₂ sorbent comprising an ionic liquid containing a potentially nucleophilic carbon atom bearing a relatively acidic hydrogen atom bonded to a potentially nucleophilic carbon atom to sorb CO₂ into the solution; and
b) treating the sorbent containing the sorbed CO₂ under conditions including a second temperature, to cause desorption of at least a portion of the CO₂ and to regenerate the ionic liquid.

2. The process of claim 1, wherein the relatively acidic hydrogen atom of the ionic liquid cation is bonded to a potentially nucleophilic carbon atom in a conjugated —NC(H)N— structure or a —NC(H)S— structure.

3. The process of claim 1 wherein the ionic liquid solvent comprises an imidazolium, imidazolidinium, benzimidazolium or thiazolium salt.

4. The process of claim 3, wherein the imidazolium, imidazolidinium, benzimidazolium or thiazolium salt is a salt having a counterion derived from an organic acid with a pKa of at least 4.0.

5. The process of claim 4, wherein the imidazolium, imidazolidinium, benzimidazolium or thiazolium salt is an acetate or other carboxylate salt.

6. The process of claim 1, wherein the gas stream is contacted with a CO₂ sorbent comprising (i) an ionic liquid containing a potentially nucleophilic carbon atom bearing a relatively acidic hydrogen atom bonded to a potentially nucleophilic carbon atom and (ii) a non-nucleophilic nitrogenous base having a pKa of at least 10.0 (25° C. aqueous equivalent scale).

7. The process of claim 6, wherein the non-nucleophilic nitrogenous base has a pKa of at least 12.

8. The process of claim 6, wherein the non-nucleophilic nitrogenous base is a carboxamidine or guanidine.

9. The process of claim 1, wherein the first temperature is from 25° C. to 50° C. and the second temperature is not greater than 100° C.

10. The process of claim 1, wherein the second temperature is higher than the first temperature.

11. The process of claim 10, wherein the first temperature is from 70 to 100° C. and the second temperature is greater than 100° C.

12. The process of claim 1, wherein the second temperature is not more than 30° C. higher than the first temperature.

13. A method of separating CO₂ from a mixed gas stream in a continuous cyclic sorption-desorption process which comprises:
a) contacting the gas stream in a gas/liquid sorption zone with a circulating stream of a non-aqueous liquid sorbent medium comprising an ionic liquid containing a potentially nucleophilic carbon atom bearing a relatively acidic hydrogen atom bonded to a potentially nucleophilic carbon atom under conditions to form a rich solution of CO₂ sorbed in the liquid sorbent medium;
b) passing the a rich solution of CO₂ sorbed in the liquid sorbent medium to a regeneration zone wherein CO₂ is desorbed from the rich solution in the liquid sorbent medium under conditions required for desorption of the CO₂ thereby producing a regenerated lean solution; and
c) cycling the resulting regenerated lean solution with reduced CO2 content to the sorption zone.

14. The process of claim 13, wherein the relatively acidic hydrogen atom of the ionic liquid cation is bonded to a potentially nucleophilic carbon atom in a conjugated —NC(H)N— structure or a —NC(H)S— structure.

15. The process of claim 13, wherein the ionic liquid comprises an imidazolium, imidazolidinium or thiazolium salt.

16. The process of claim 15, wherein the salt is a imidazolium, imidazolidinium, benzimidazolium or thiazolium salt having a counterion derived from an organic acid with a pKa of at least 4.0.

17. The process of claim 16, wherein the imidazolium, imidazolidinium, benzimidazolium or thiazolium salt is an acetate or other carboxylate salt.

18. The process of claim 13, wherein the gas stream is contacted with the non-aqueous liquid sorbent medium at a first temperature and the rich solution containing the sorbed CO₂ is treated under conditions including a second temperature which is higher than the first temperature to cause desorption of at least a portion of the CO₂.

19. The process of claim 14, wherein the first temperature is from 70 to 100° C. and the second temperature is greater than 100° C.

20. The process of claim 15, wherein the second temperature is not more than 30° C. higher than the first temperature.
